(19) United States
(12) Patent Application Publication
(10) Pub. No.: US 2008/0028895 A1
(43) Pub. Date: Feb. 7, 2008

(54) BOTTLE OPENER

(76) Inventor: Yi-Tan Chan, Taipei (TW)

Correspondence Address: PAI PATENT & TRADEMARK LAW FIRM, 1001 FOURTH AVENUE, SUITE 3200, SEATTLE, WA, 98154, US

(21) Appl. No.: 11/741,758

(22) Filed: Apr. 29, 2007

(30) Foreign Application Priority Data
Jun. 14, 2006 (TW) 095210332

(51) Int. Cl. B25B 13/52

(52) U.S. Cl. 81/64

(57) ABSTRACT

A bottle opener has a handle, a magnet and a screw-band. The handle has a front end, a rear end, a top surface, a bottom surface, two sides and a hook. The hook is formed at the front end of the handle and curves towards the bottom surface and allows a person to remove a crown cap. The magnet is mounted in the handle and prevents the crown cap from falling. The screw-band is resilient, is connected to the handle and has an inner surface, an outer surface and a central hole defined axially through the screw-band. The bottle opener with the screw-band allows the person to remove the threaded cap without making direct contact. Therefore, sharp pieces or edges of the threaded cap cannot inadvertently cut the person's hands.

### BACKGROUND OF THE INVENTION

1. Field of the Invention

The present invention relates to a bottle opener, and more particularly to a bottle opener capable of opening both a crown cap and a threaded cap.

2. Description of Related Art

Beverages such as cola and beers can be packaged in bottles with a cap. The bottles have a top. The top has an outer edge. The cap may be a threaded cap or a crown cap. The threaded cap is screwed onto the top of a threaded bottle. The crown cap is press-fitted on the outer edge at the top of a crown bottle.

To remove a crown cap from a bottle a person uses a bottle opener. A bottle opener has a handle with a hook on one end. However, a bottle opener cannot remove a threaded cap. Sometimes, a person's hand alone cannot provide enough friction to gain a good grip for the removal of the threaded cap. Furthermore, the threaded cap may have a sharp piece or edge that could cut or pierce the persons' hands while they screw off the threaded cap.

To overcome the shortcomings, the present invention provides a bottle opener to mitigate or obviate the aforementioned problems.

### SUMMARY OF THE INVENTION

The main objective of the invention is to provide a bottle opener capable of opening both a crown cap and a threaded cap.

A bottle opener has a handle, a magnet and a screw-band. The handle has a front end, a rear end, a top surface, a bottom surface, two sides and a hook. The hook is formed at the front end of the handle and curves towards the bottom surface and allows a person to remove a crown cap. The magnet is mounted on the handle near the hook. The screw-band is resilient, is connected to the handle and has an inner surface, an outer surface and a central hole defined axially through the screw-band. The bottle opener with the screw-band allows the person to remove the threaded cap without making direct contact. Therefore, sharp pieces or edges of the threaded cap cannot inadvertently cut the person's hands.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a bottle opener in accordance with the present invention;

FIG. 2 is an exploded perspective view of the bottle opener in FIG. 1;

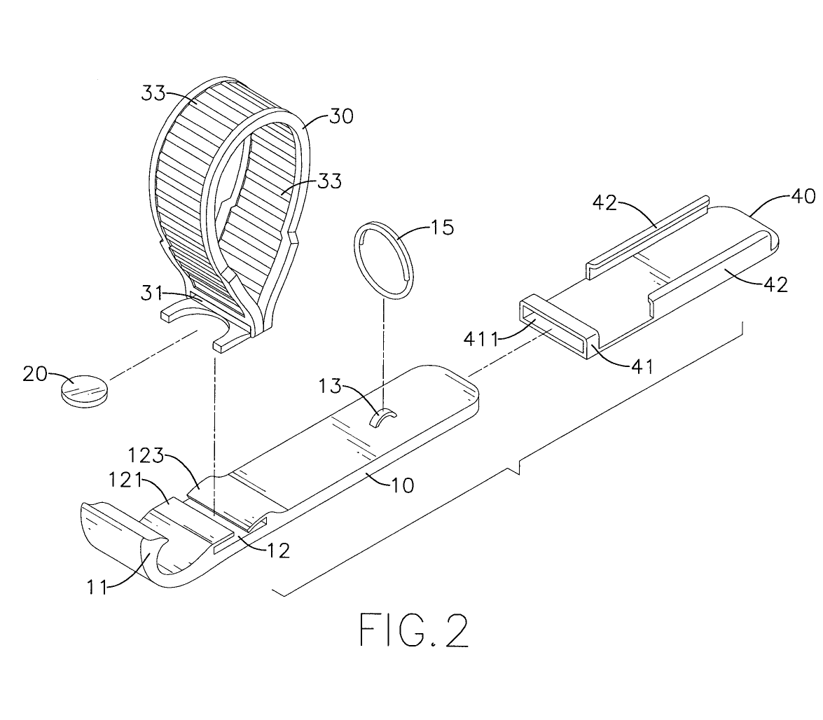

FIG. 3 is an operational perspective view of the bottle opener in FIG. 1 with the extension arm extending out from the rear end of the handle;

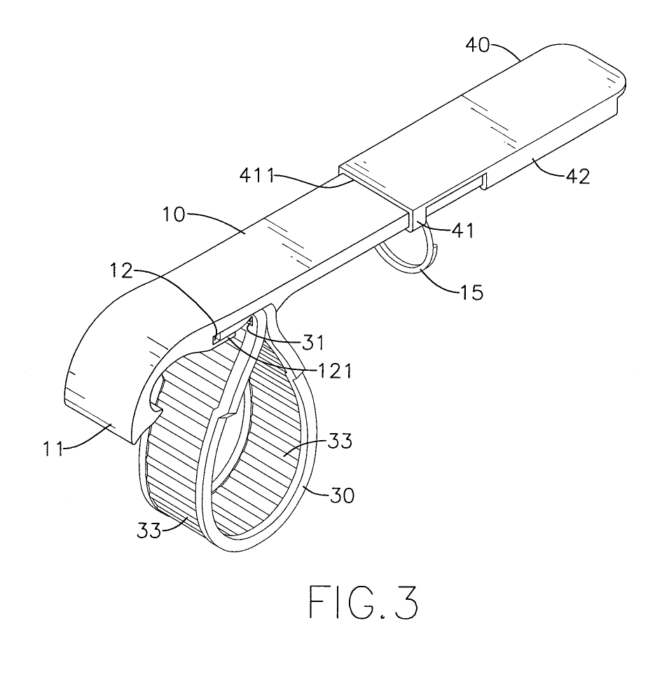

FIG. 4 is an operational cross sectional side view of the bottle opener in FIG. 3;

FIG. 5 is an operational top view of a user holding and rotating the screw-band of the bottle opener in FIG. 1 around the threaded cap of the bottle to remove the threaded cap;

FIG. 6 is an operational side view of a user opening the crown cap on the bottle with the hook of the bottle opener in FIG. 1 engaging the bottom edge of the crown cap; and

FIG. 7 is a perspective view of a second embodiment of a bottle opener in accordance with the present invention implemented without the extension arm, key-ring mount and key ring.

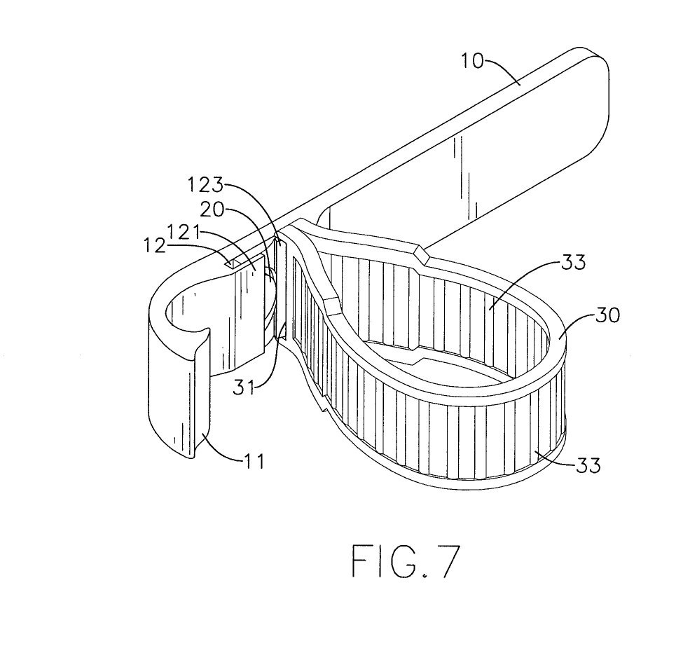

### DETAILED DESCRIPTION OF THE PREFERRED EMBODIMENT

The present invention is used to open a beverage bottle. A beverage bottle has a top and a cap and may be a threaded bottle (80) or a crown-capped bottle (90). The cap has a side and a bottom edge. The side of the cap has an inside surface, an outside surface and a bottom edge. The cap may be a threaded cap (81) or a crown cap (91). The threaded cap (81) has a thread around the inside surface of the side that engages with the thread at the top of the threaded bottle (80) to close the bottle. The crown cap (91) has multiple teeth. The teeth abut a flange at the top of the crown-capped bottle (90) to close the bottle.

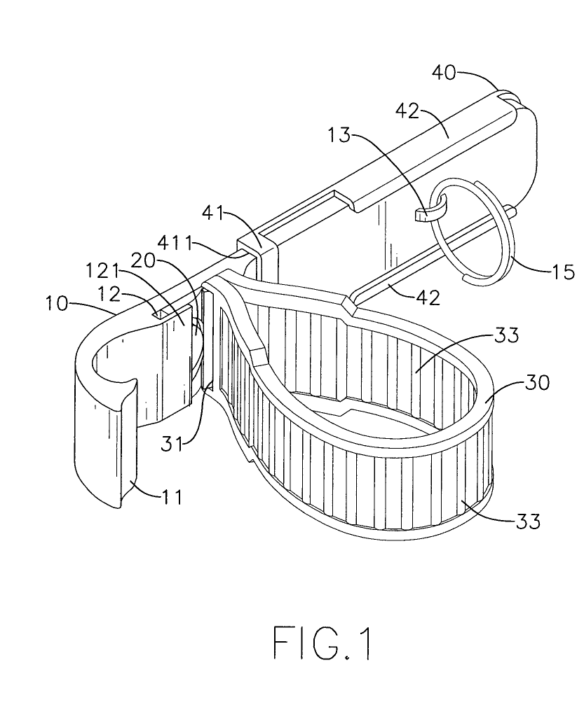

With reference to FIGS. 1,2, 3 and 7, a bottle opener in accordance with the present invention comprises a handle (10), a magnet (20), a screw-band (30) and an extension arm (40).

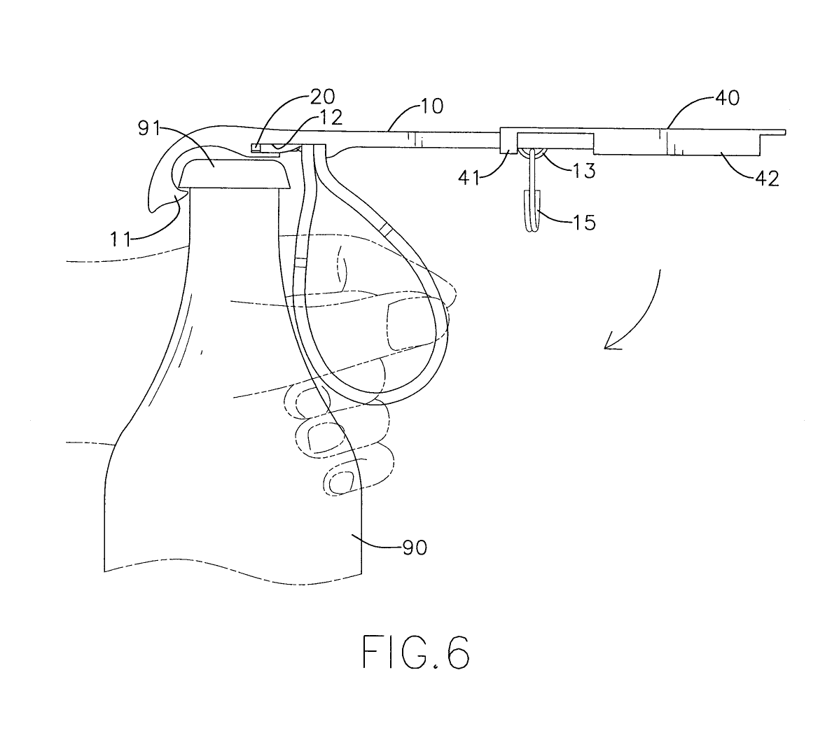

With further reference to FIG. 6, the handle (10) has a front end, a rear end, a top surface, a bottom surface, two opposite sides, a hook (11), a mounting recess (12), a key ring mount (13) and a key ring (15).

The hook (11) is formed at the front end of the handle (10) and is curved towards the bottom surface. The hook (11) engages with the bottom edge of a crown cap (91). Pressing the rear end of the handle (10) causes the hook (11) to lift and remove the crown cap (91).

The mounting recess (12) is defined in the bottom surface of the handle (10). The mounting recess (12) has an inner bottom surface, a front inside surfaces, a rear inside surface, a magnet holder (121) and a band mount (123). The magnet holder (121) is formed on and protrudes from the front inside surface of the mounting recess (12).

The band mount (123) is formed on and protrudes from the rear inside surface.

The key ring mount (13) is formed on the bottom surface of the handle (10) and has a through hole defined through the key ring mount (13).

The key ring (15) is annular, is mounted through the key ring mount (13) and may connect to articles with holes such as keys, key chains, carry straps and the like.

The magnet (20) is connected to the handle (10) near the hook (11), is mounted in the mounting recess (12) between the inner bottom surface and the magnet holder (121) and is pressed against and held by the magnet holder (121). The magnet holds the removed crown cap (91) to prevent the crown cap (91) from falling on the ground.

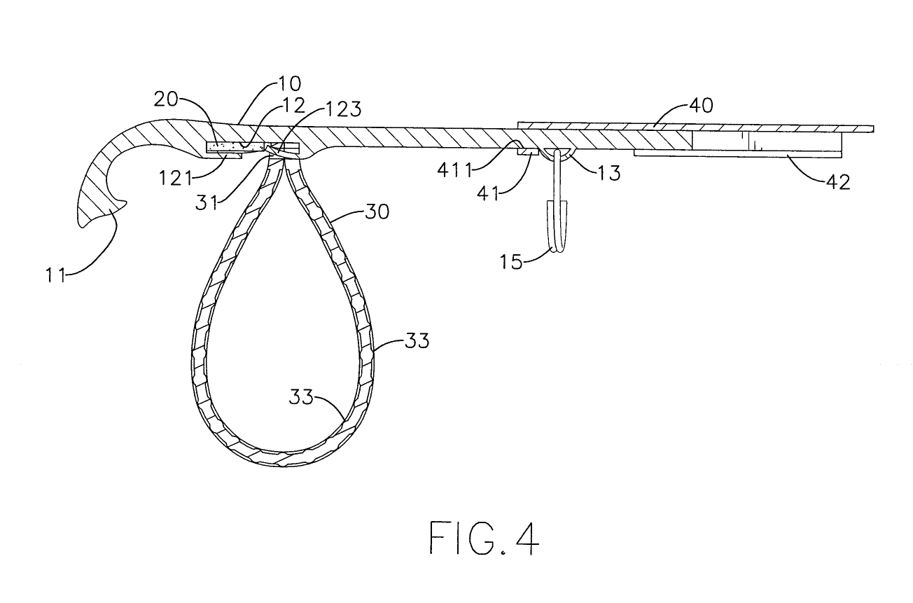

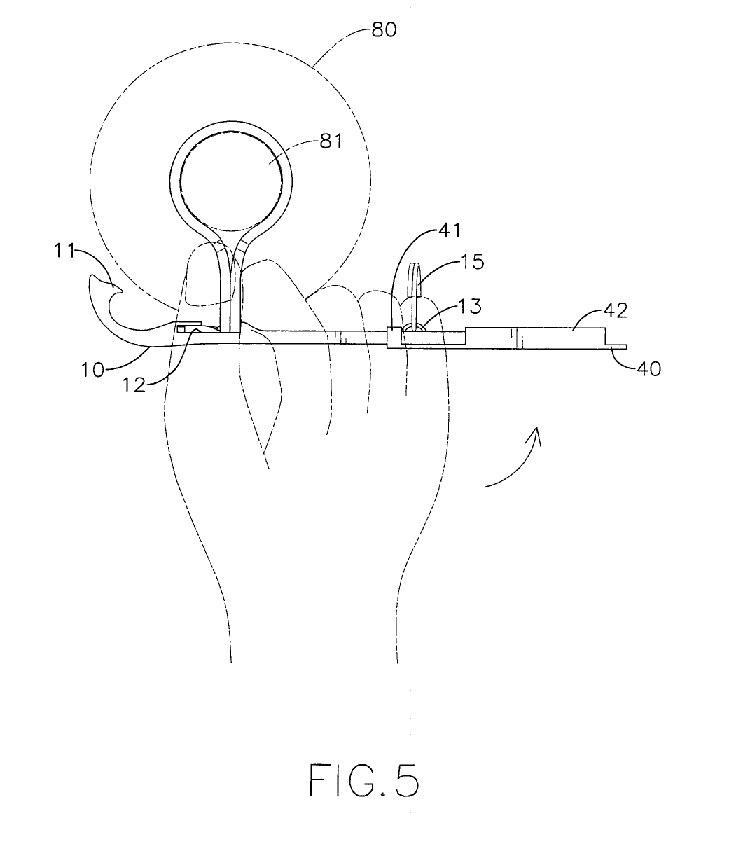

With further reference to FIGS. 4 and 5, the screw-band (30) is resilient, is looped and is formed from a longitudinal strap. The screw-band (30) is connected to the handle (10) near the hook (11) and has two ends, two mounting holes (31), an inner surface, an outer surface, an inner set of multiple high-friction ribs (33), an outer set of multiple high-friction ribs (33) and a central hole.

The ends of the screw-band (30) are attached to the handle (10), are mounted preferably in the mounting recess (121) in the handle (10).

The mounting holes (31) are defined respectively through the ends of the screw-band (30) and are mounted around the band mount (123) so that the band mount (123) holds the ends of the screw-band (30).

The inner and outer sets of the ribs (33) are formed respectively on the inner and outer surfaces.

The central hole is defined axially through the screw-band (30) and may be mounted around the threaded cap (81) to open a threaded bottle (80).

When used to the remove the threaded cap (81) on the bottle (80), the screw-band (30) is mounted around the threaded cap (81). A person clips the screw-band (30) with fingers to reduce the central hole and make the inner surface of the screw-band (30) press tightly against the outer surface of the threaded cap (81). Then, the person rotates the screw-band (30) to screw off the threaded cap (81). The high-friction ribs (33) prevent the fingers or threaded cap (81) from slipping relative to the screw-band (30).

The extension arm (40) is mounted on the handle (10) and selectively extending out of the rear end of the handle (40) to increase pivoting torque to aid the removal of the crown cap (91). The extension arm (40) has a front end, a rear end, two sides, a mounting bracket (41) and two slide retainers (42).

The mounting bracket (41) is formed on the front end of the extension arm (40) and has a mounting hole (411). The mounting hole (411) is defined longitudinally through the mounting bracket (41) and is mounted slidably around the handle (10).

The slide retainers (42) are L-shaped in cross-section. The slide retainers (42) are formed respectively on and protrude respectively from the sides of the extension arm (40) and are mounted slidably on and hold the sides of the handle (10).

The bottle opener with the screw-band (30) allows people to remove the threaded cap (81) without directly contacting the threaded cap (81) so sharp pieces or edges of the threaded cap (81) cannot inadvertently cut their hands. The screw-band presses tightly against the threaded cap (81) to prevent the screw-band (30) sliding in relation to the threaded cap (81). Furthermore, the extension arm (40) makes the operation of removing the crown cap (91) easier compared with conventional bottle openers.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A bottle opener comprising
a handle having
a front end;
a rear end;
a top surface;
a bottom surface;
two opposite sides; and
a hook formed at the front end of the handle and curving towards the bottom surface;
a magnet mounted in the handle; and
a screw-band being resilient, being looped, connected to the handle and having
two ends attached to the handle;
an inner surface;
an outer surface; and
a central hole defined axially through the screw-band.

2. The bottle opener as claimed in claim 1 further comprising an extension arm mounted on the handle and selectively extending out of the rear end of the handle.

3. The bottle opener as claimed in claim 1, wherein:
the handle further has a mounting recess defined in the bottom surface and having
an inner bottom surface;
a front inside surface; and
a rear inside surface;
the magnet is mounted in the mounting recess; and
the ends of the screw-band are mounted in the mounting recess.

4. The bottle opener as claimed in claim 1, wherein the screw-band further has multiple high-friction ribs formed on the inner surface of the screw-band.

5. The bottle opener as claimed in claim 1, wherein the screw-band further has multiple high-friction ribs formed on the outer surface of the screw-band.

6. The bottle opener as claimed in claim 1, wherein a key ring mount formed on the bottom surface of the handle and has a through hole defined through the key ring mount.

7. The bottle opener as claimed in claim 1, wherein a key ring is annular and is mounted through the key ring mount.

8. The bottle opener as claimed in claim 2, wherein the extension arm has
a front end;
a rear end;
two opposite sides;
a mounting bracket formed on the front end of the extension arm and having a mounting hole defined longitudinally through the mounting bracket and mounted slidably around the handle; and
two slide retainers being L-shaped, formed respectively on and protruding respectively from the sides of the extension arm and mounted slidably on and holding the sides of the handle.

9. The bottle opener as claimed in claim 3, wherein:
the mounting recess further has a band mount formed on and protruding from the rear inside surface of the mounting recess; and
the screw-band further has two mounting holes mounted respectively through the ends of the screw-band and mounted around the band mount so that the band mount holds the ends of the screw-band.

10. The bottle opener as claimed in claim 3, wherein the mounting recess further has a magnet holder formed on and protruding from the front inside surface of the mounting recess and pressing against and holding the magnet.
